(19) United States
(12) Patent Application Publication
(10) Pub. No.: US 2026/0186199 A1
(43) Pub. Date: Jul. 2, 2026

(54) BACKLIGHT UNIT AND LIQUID CRYSTAL DISPLAY DEVICE

(71) Applicant: Shanghai Tianma Micro-Electronics Co., Ltd., Shanghai (CN)

(72) Inventor: Toru OHKI, Kawasaki (JP)

(73) Assignee: Shanghai Tianma Micro-Electronics Co., Ltd., Shanghai (CN)

(21) Appl. No.: 19/408,600

(22) Filed: Dec. 4, 2025

(30) Foreign Application Priority Data
Dec. 26, 2024 (JP) 2024-229860
Sep. 24, 2025 (JP) 2025-158585

(51) Int. Cl. F21V 8/00; G02F 1/13357

(52) U.S. Cl. CPC G02B 6/0095; G02F 1/1336

(57) ABSTRACT

A backlight unit includes a light source and a light guide plate. The light guide plate includes a side surface facing the light source, a first main surface through which light from the light source is output, and a second main surface opposite to the first main surface. The light guide plate includes a recess disposed on the second main surface. The recess includes a bottom surface and a circumferential surface continuous to the bottom surface, and the circumferential surface is obtusely inclined from the bottom surface when viewed in a plane perpendicular to the second main surface.

### CROSS-REFERENCE TO RELATED APPLICATIONS

This application claims the benefit of Japanese Patent Application No. 2024-229860, filed on December 26, 2024, and Japanese Patent Application No. 2025-158585, filed on September 24, 2025, the entire disclosure of which is incorporated by reference herein.

### FIELD OF THE INVENTION

This application relates to a backlight unit and a liquid crystal display device.

### BACKGROUND OF THE INVENTION

Some liquid crystal display devices have been known each including a camera behind a liquid crystal display panel. For example, U.S. Patent Application Publication No. 2021/0088842 discloses an electronic device including a camera, a liquid crystal panel having a display region overlapping with the camera, a light guide plate having a through hole, and light sources facing a side surface of the light guide plate. The camera is disposed within the through hole of the light guide plate. U.S. Patent Application Publication No. 2009/0102763 discloses a backlight system for emitting light to a liquid crystal display panel, provided with a light guide plate having a hole (recess) that houses an image capture device.

In U.S. Patent Application Publication No. 2021/0088842, the through hole of the light guide plate inhibits transmission of the light, emitted from the light sources, beyond the through hole within the light guide plate. The inhibited light transmission causes a decreased luminance of the light guide plate in the portion on the side of the through hole opposite to the light sources, resulting in a non-uniform luminance distribution in the light guide plate. In U.S. Patent Application Publication No. 2009/0102763, the portion of the light guide plate including the hole has a reduced thickness, although the hole does not extend through the light guide plate. This thinner portion in U.S. Patent Application Publication No. 2009/0102763 also inhibits transmission of the light, emitted from light sources, beyond the hole within the light guide plate. The inhibited light transmission causes a decreased luminance of the light guide plate in the portion on the side of the hole opposite to the light sources.

### SUMMARY OF THE INVENTION

A backlight unit according to a first aspect of the present disclosure includes:

a light source; and

a light guide plate including

a side surface facing the light source,

a first main surface through which light from the light source is output, and

a second main surface opposite to the first main surface, wherein

the light guide plate includes a recess disposed on the second main surface,

the recess includes a bottom surface and a circumferential surface continuous to the bottom surface, and

the circumferential surface is obtusely inclined from the bottom surface when the recess is viewed in a plane perpendicular to the second main surface.

A liquid crystal display device according to a second aspect of the present disclosure includes:

the backlight unit; and

a liquid crystal display panel disposed on the first main surface of the light guide plate and including a display region to display screen elements, wherein

the recess of the light guide plate overlaps with the display region of the liquid crystal display panel in plan view.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a sectional view of a liquid crystal display device according to Embodiment 1;

FIG. 2 is a plan view of light sources, a light guide plate, optical sheets, and a lower chassis of a backlight unit according to Embodiment 1;

FIG. 3 is a plan view of the light guide plate according to Embodiment 1;

FIG. 4 is a sectional view of the light guide plate taken along the line A-A of FIG. 3;

FIG. 5 is a schematic diagram for describing light propagation within the light guide plate with a recess that is entirely provided as a circular-column depression;

FIG. 6 is a schematic diagram for describing light propagation within the light guide plate according to Embodiment 1;

FIG. 7 is a plan view illustrating the dimensions of a light guide plate in a simulation in Embodiment 1;

FIG. 8 is a sectional view illustrating the dimensions of the light guide plate in the simulation in Embodiment 1;

FIG. 9 is a sectional view illustrating the dimensions of a light guide plate in a simulation in Comparative Example 1;

FIG. 10 is a sectional view illustrating the dimensions of a light guide plate in a simulation in Comparative Example 2;

FIG. 11 is a sectional view illustrating the dimensions of a light guide plate in a simulation in Comparative Example 3;

FIG. 12 illustrates a luminance distribution on a light exit surface in the simulation in Embodiment 1;

FIG. 13 illustrates a luminance distribution on a light exit surface in the simulation in Comparative Example 1;

FIG. 14 illustrates a luminance distribution on a light exit surface in the simulation in Comparative Example 2;

FIG. 15 illustrates a luminance distribution on a light exit surface in the simulation in Comparative Example 3;

FIG. 16 illustrates a luminance distribution along a line on each of the light exit surfaces in the simulations in Embodiment 1 and Comparative Examples 1 to 3;

FIG. 17 is a plan view illustrating portions in the simulation in Embodiment 1;

FIG. 18 is a sectional view illustrating the portions in the simulation in Embodiment 1;

FIG. 19 illustrates the relationship between the angle of a circumferential surface of a recess and the ratio of light rays transmitted beyond the recess in Embodiment 1;

FIG. 20 is a sectional view of a liquid crystal display device according to Embodiment 2;

FIG. 21 is a plan view of a light guide plate according to Embodiment 2;

FIG. 22 is a cross-sectional view of the light guide plate illustrated in FIG. 21, taken along line B-B;

FIG. 23 is a schematic diagram for describing light propagation within the light guide plate according to Embodiment 2;

FIG. 24 is a sectional view illustrating the dimensions of a light guide plate in a simulation in Embodiment 2;

FIG. 25 illustrates a luminance distribution on a light exit surface in the simulation in Embodiment 2;

FIG. 26 illustrates a luminance distribution along a line on each of the light exit surfaces in the simulations in Embodiment 2 and Comparative Examples 1 to 3;

FIG. 27 illustrates the relationship between the angle of a circumferential surface of a protrusion or the angle of a circumferential surface of a recess, and the ratio of light rays transmitted beyond the recess in Embodiment 2;

FIG. 28 illustrates the relationship between the diameter of a bottom surface of a protrusion and the ratio of light rays transmitted beyond a recess in Embodiment 3;

FIG. 29 illustrates luminance distributions along a line on a light exit surface in simulations in Embodiment 3;

FIG. 30 illustrates luminance distributions along a line on the light exit surface in simulations in Embodiment 3; and

FIG. 31 is a sectional view illustrating a recess and a lens of an imaging unit according to a modification.

### DETAILED DESCRIPTION OF THE INVENTION

A backlight unit and a liquid crystal display device according to some embodiments are described below with reference to the accompanying drawings.

### Embodiment 1

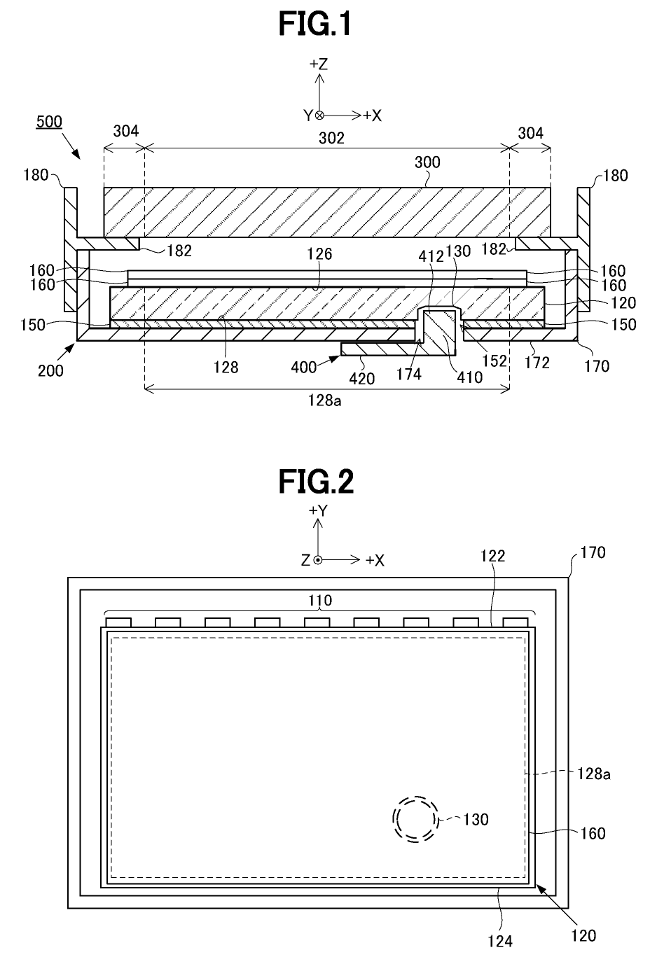

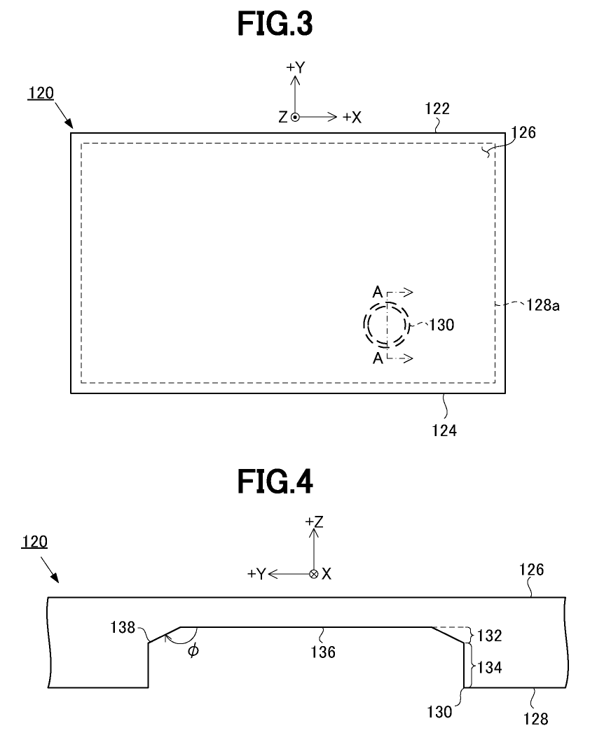

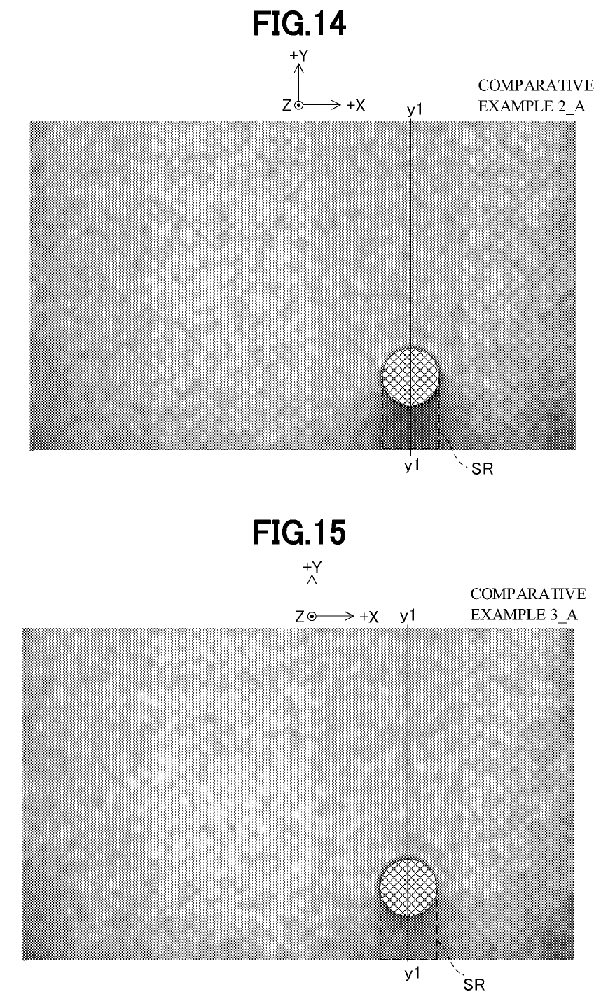

The following describes a backlight unit 200 and a liquid crystal display device 500 according to the embodiment, with reference to FIGS. 1 to 19. As illustrated in FIG. 1, the liquid crystal display device 500 includes a backlight unit 200, a liquid crystal display panel 300, and an imaging unit 400. The backlight unit 200 includes light sources 110 and a light guide plate 120, which are described below. The liquid crystal display panel 300 includes a display region 302 that displays screen elements (characters, images, and other information), and a frame region 304 surrounding the display region 302. The imaging unit 400 includes a lens segment 410 and a body segment 420. This specification defines the longitudinal direction of the liquid crystal display device 500 in FIG. 1 (or the rightward direction on the plane of the figure) as the +X direction, the transverse direction (or the rearward direction on the plane of the figure) as the +Y direction, and the direction perpendicular to the +X and +Y directions (or the upward direction on the plane of the figure or the direction toward a user) as the +Z direction. FIG. 1 illustrates optical sheets 160, which are described below, without hatching, in order to facilitate understanding. The other figures may also illustrate components without hatching.

The description first focuses on the backlight unit 200. The backlight unit 200 functions as illumination unit for the liquid crystal display panel 300 of the liquid crystal display device 500. As illustrated in FIGS. 1 and 2, the backlight unit 200 includes the light sources 110, the light guide plate 120, a reflective sheet 150, the optical sheets 160, a lower chassis 170, and an upper chassis 180.

The light sources 110 of the backlight unit 200 are white light emitting diode (LED) elements, for example. As illustrated in FIG. 2, the light sources 110 face a +Y side surface 122 of the light guide plate 120. The light emitted from the light sources 110 enters the light guide plate 120 through the side surface 122 of the light guide plate 120.

The light guide plate 120 of the backlight unit 200 is a rectangular plate member elongated in the X direction. The light guide plate 120 outputs the light incident from the light sources 110 toward the liquid crystal display panel 300. As illustrated in FIGS. 1 and 2, the light guide plate 120 has a first main surface 126 through which the light incident from the light sources 110 is output toward the liquid crystal display panel 300, and a second main surface 128 opposite to the first main surface 126. The light guide plate 120 also has four side surfaces including the side surface 122 facing the light sources 110, and a side surface 124 opposite to the side surface 122. The following description also refers the first main surface 126 as “light exit surface 126”, the side surface 122 facing the light sources 110 as “light incident surface 122”, and the side surface 124 opposite to the side surface 122 as “opposite surface 124”.

As illustrated in FIGS. 1 to 3, the light guide plate 120 has a recess 130 in an area 128a of the second main surface 128 corresponding to the display region 302 of the liquid crystal display panel 300. The recess 130 houses an end 412 of the lens segment 410 of the imaging unit 400, as illustrated in FIG. 1.

The recess 130 includes a rim segment 134 (-Z-side segment of the recess 130) that defines a circular-column depression, and the bottom segment 132 (+Z-side segment of the recess 130) that defines a mortar-like (truncated-cone) depression. In other words, in a cross-sectional view of the recess 130 in a plane perpendicular to the second main surface 128 as illustrated in FIG. 4, the recess 130 has a circumferential surface 138 continuous to and obtusely inclined from a bottom surface 136 of the recess 130. The circumferential surface 138 of the recess 130 preferably has an inclination angle φ of 150° or larger from the bottom surface 136 of the recess 130, as described below.

The light guide plate 120 is made of a light permeable resin (for example, polycarbonate). A typical example of the light guide plate 120 is provided with a diffusion layer, which is not illustrated, printed in a predetermined dot pattern on the second main surface 128 except for the recess 130, to output the light propagating within the light guide plate 120 through the first main surface 126.

As illustrated in FIG. 1, the reflective sheet 150 of the backlight unit 200 is stacked on the second main surface 128 of the light guide plate 120. The reflective sheet 150 reflects the light output through the second main surface 128 of the light guide plate 120, toward the light guide plate 120. The reflective sheet 150 has a through hole 152 through which the lens segment 410 of the imaging unit 400 passes.

As illustrated in FIGS. 1 and 2, the optical sheets 160 of the backlight unit 200 are stacked on the first main surface 126 of the light guide plate 120. Examples of the optical sheets 160 include a diffusion sheet, a prism sheet, and a polarizing reflective sheet.

The lower chassis 170 of the backlight unit 200 is shaped as a box with an open top. The lower chassis 170 is made of a resin or metal. As illustrated in FIG. 1, the lower chassis 170 accommodates the light sources 110, the light guide plate 120, the reflective sheet 150, and the optical sheets 160. The lower chassis 170 has a bottom 172 having a through hole 174 through which the lens segment 410 of the imaging unit 400 passes.

The upper chassis 180 of the backlight unit 200 has a frame shape. As illustrated in FIG. 1, the upper chassis 180 has a projection 182 extending inward. The projection 182 receives the liquid crystal display panel 300 mounted thereon. The upper chassis 180 is made of a synthetic resin, for example.

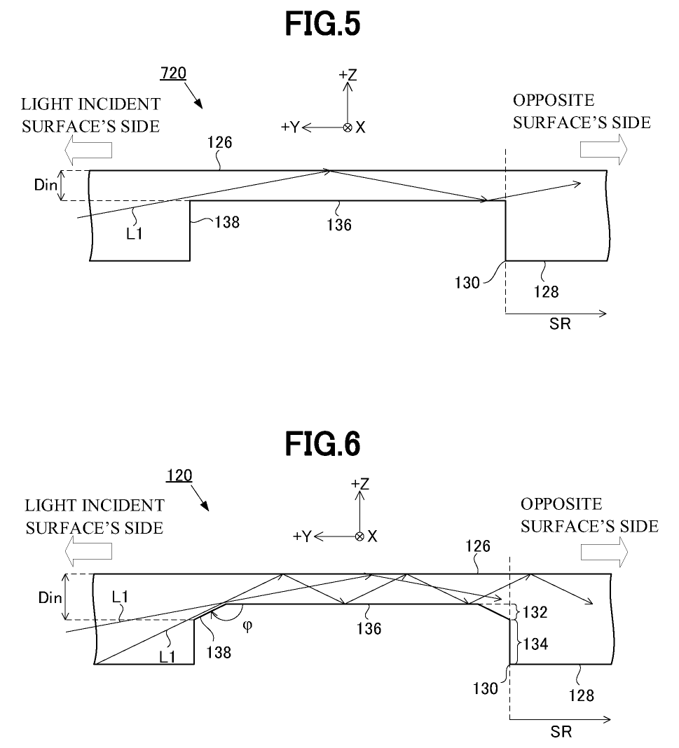

The embodiment can bring about effects described below. For example, in the light guide plate 720 illustrated in FIG. 5, where the recess 130 is entirely provided as a circular-column depression (with the circumferential surface 138 continuous with the bottom surface 136 being perpendicular to the bottom surface 136), the width Din for guiding light L1 from the side adjacent to the light incident surface 122 into the portion of the light guide plate 120 above the recess 130 is narrow. This narrow width Din reduces the intensity of the light transmitted beyond the recess 130 to an opposite portion SR of the light guide plate 720 as viewed from the light incident surface 122. Such a reduction in the light intensity lowers the luminance Lu in the portion SR of the light guide plate 720 on the opposite side of the recess 130, resulting in a non-uniform luminance distribution in the light guide plate 720 (light exit surface 126).

In contrast, according to the embodiment, in a cross-sectional view of the recess 130 in a plane perpendicular to the second main surface 128, the recess 130 has a circumferential surface 138 continuous to and obtusely inclined from a bottom surface 136 of the recess 130, which results in wider width Din, as illustrated in FIG. 6. These functions can enhance the intensity of the light transmitted to the portion SR of the light guide plate 120, and thus increase the luminance Lu in the portion SR of the light guide plate 120, leading to a more uniform luminance distribution in the light guide plate 120 (light exit surface 126).

The following describes specific effects of the embodiment, on the basis of ray-trace simulations, using the illumination analysis software “LightTools” available from Nihon Synopsys G.K. The description first focuses on the components including the light sources 110 and the light guide plate 120 simulated in the embodiment.

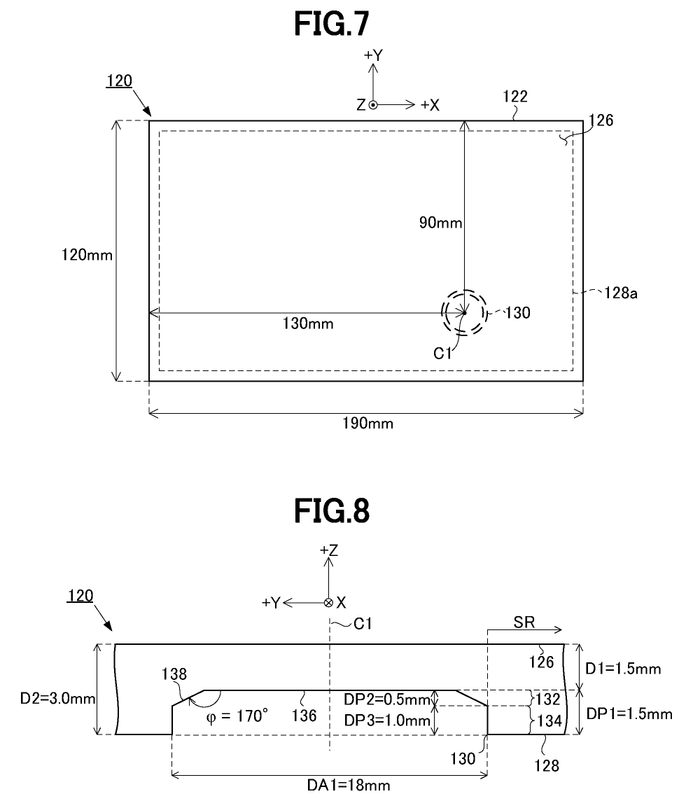

As illustrated in FIG. 7, the light guide plate 120 measures 190 mm (X direction) by 120 mm (Y direction). The recess 130 has a central axis C1 positioned 90 mm in the -Y direction from the light incident surface 122 and 130 mm in the +X direction from the left side surface. The light sources 110 are made of 28 white LED elements (not illustrated) aligned at a pitch of 6.5 mm while facing the light incident surface 122.

As illustrated in FIG. 8, the portion of the light guide plate 120 above the recess 130 has a thickness D1 of 1.5 mm, and the light guide plate 120 has a thickness D2 of 3 mm. Furthermore, the recess 130 has a depth DP1 of 1.5 mm, the bottom segment 132 of the recess 130 has a depth DP2 of 0.5 mm, and the rim segment 134 has a depth DP3 of 1.0 mm. The recess 130 has a diameter DA1 of 18 mm. The circumferential surface 138 of the recess 130 is continuous to and forms an angle φ of 170° from the bottom surface 136 of the recess 130. The recess 130 in this simulation is provided with a light absorber, which is not illustrated, in place of the lens segment 410 of the imaging unit 400.

The second main surface 128 except for the recess 130 is provided with the diffusion layer (not illustrated) in a dot pattern. Exemplary patterns of the diffusion layer include a pattern (hereinafter referred to as “pattern A”) that generates a uniform luminance distribution in a light guide plate including no recess 130.

The following describes light guide plates 820, 840, and 860 simulated in Comparative Examples 1 to 3, respectively. The light sources 110 and the light guide plates 820, 840, and 860 in the simulations in Comparative Examples 1 to 3 have the same sizes and thicknesses as those in the simulation in the embodiment.

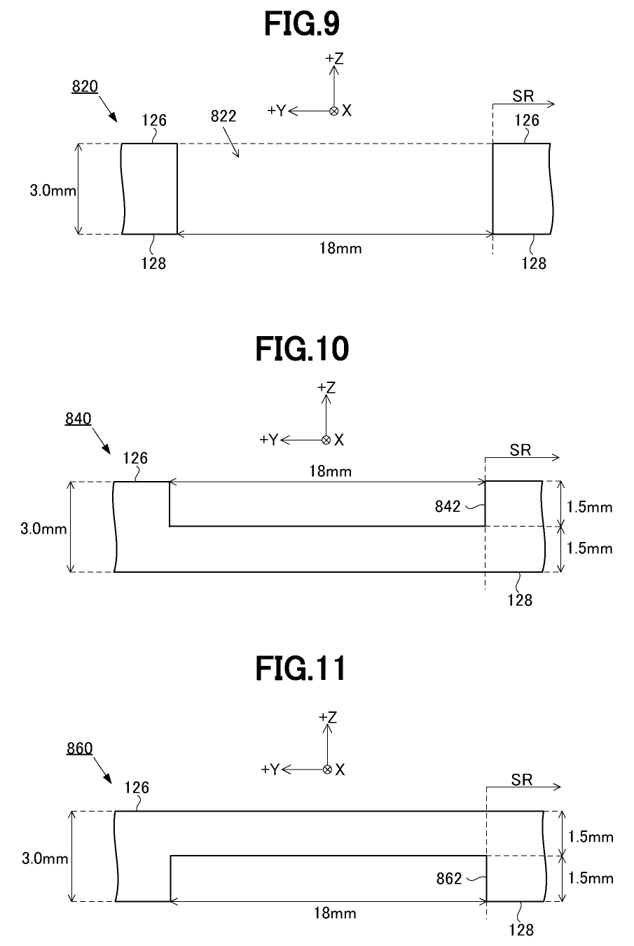

As illustrated in FIG. 9, the light guide plate 820 in Comparative Example 1 includes a circular-column through hole 822 in place of the recess 130. The through hole 822 is located at the same position as the recess 130 in the embodiment, and has the same diameter as the diameter DA1 of the recess 130 in the embodiment. The through hole 822 is provided with a light absorber therein. Comparative Example 1 also uses the pattern A of diffusion layer.

As illustrated in FIG. 10, the light guide plate 840 in Comparative Example 2 includes a circular-column recess 842 on the first main surface 126. The recess 842 is located at the same position as the recess 130 in the embodiment. The recess 842 has the same diameter as the diameter DA1 of the recess 130 in the embodiment. The recess 842 has a depth of 1.5 mm. The portion of the light guide plate 840 below the recess 842 has a thickness of 1.5 mm. Comparative Example 2 also uses the pattern A of diffusion layer. The recess 842 is provided with a light absorber therein.

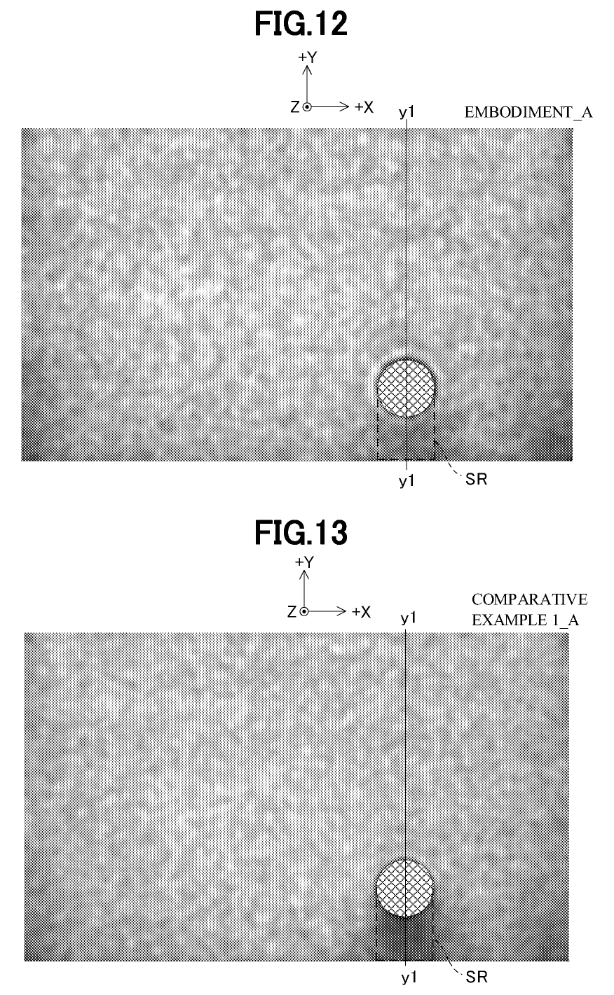

As illustrated in FIG. 11, the light guide plate 860 in Comparative Example 3 includes a circular-column recess 862 on the second main surface 128. The recess 862 is located at the same position as the recess 130 in the embodiment. The recess 862 has the same diameter as the diameter DA1 of the recess 130 in the embodiment. The recess 862 has a depth of 1.5 mm. The portion of the light guide plate 860 above the recess 862 has a thickness of 1.5 mm. Comparative Example 3 also uses the pattern A of diffusion layer. The recess 862 is provided with a light absorber therein.

The light guide plate 120 in the embodiment and the light guide plates 820, 840, and 860 in Comparative Examples 1 to 3 were compared with each other by simulating a luminance distribution on each light exit surface 126 (first main surface 126).

FIGS. 12 to 15 illustrate luminance distributions in the embodiment and Comparative Examples 1 to 3. In FIGS. 12 to 15, a brighter area represents a higher luminance Lu. The hatched area in each of FIGS. 12 to 15, corresponding to the recess 130, includes not the diffusion layer but the light absorber, and thus has a luminance Lu of 0. The same holds true for the other figures.

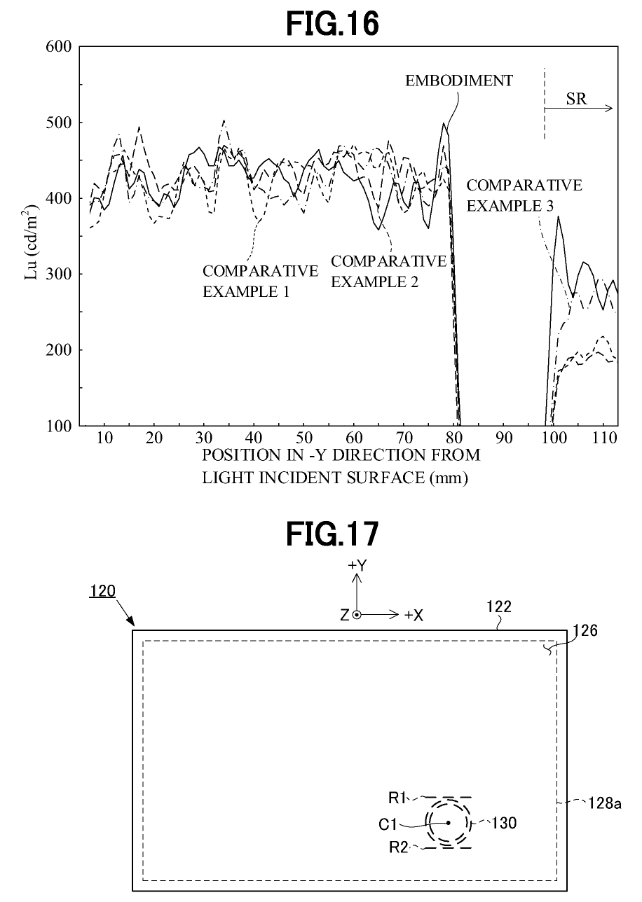

FIG. 16 illustrates a luminance distribution along the straight line (line y1-y1 in FIGS. 12 to 15) extending from the +Y side adjacent to the light incident surface 122 to the -Y side adjacent to the opposite surface 124 in parallel to the Y axis through the center of the recess 130, 842, or 862 or the through hole 822, in plan view of each of the light exit surfaces 126 in the embodiment and Comparative Examples 1 to 3.

As illustrated in FIGS. 12 to 16, the luminance Lu in the portion SR of the light guide plate 120 in the embodiment is higher than the luminance Lu in the portion SR of any of the light guide plates 820, 840, and 860 in Comparative Examples 1 to 3. The light guide plate 120 in the embodiment exhibits a more uniform luminance distribution than the light guide plates 820, 840, and 860 in Comparative Examples 1 to 3.

As above, in a cross-sectional view of the recess 130 in a plane perpendicular to the second main surface 128, the circumferential surface 138 of the recess 130 continuous to the bottom surface 136 of the recess 130 is obtusely inclined from the bottom surface 136. This structure can increase the luminance Lu in the portion SR, and achieve a uniform luminance distribution in the light guide plate 120.

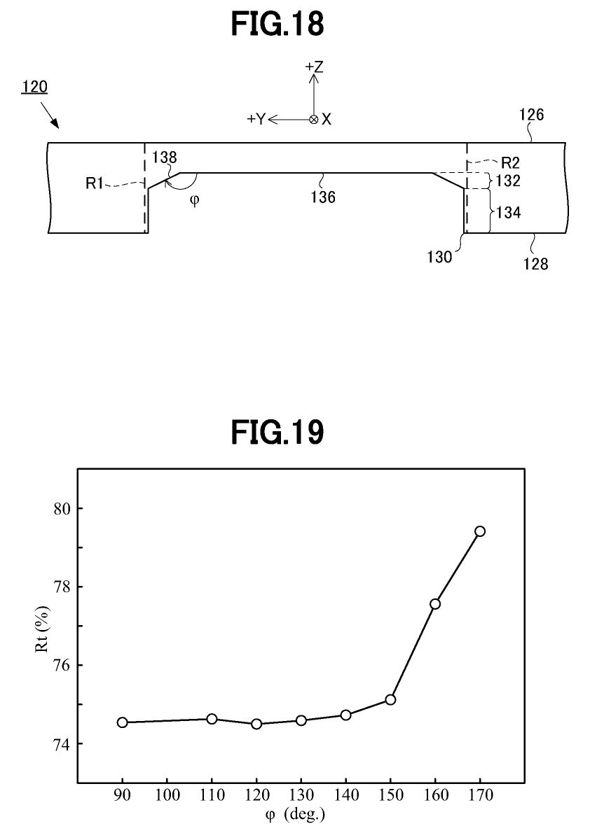

Then, the relationship between the angle φ of the circumferential surface 138 of the recess 130 and the ratio of light rays transmitted beyond the recess 130 was simulated. Specifically, a simulation was conducted to examine the relationship between the angle φ and a ratio Rt of the number of light rays passing through a portion R2 of the light guide plate 120 immediately after the recess 130 (refer to FIGS. 17 and 18) to the number of light rays passing through a portion R1 of the light guide plate 120 immediately before the recess 130 (refer to FIGS. 17 and 18), as viewed from the light incident surface 122 (side surface 122). The light guide plate 120 in this simulation has the same configuration as the light guide plate 120 in the above-described simulation, except for the value of the angle φ of the circumferential surface 138.

FIG. 19 illustrates the relationship between the angle φ of the circumferential surface 138 and the ratio Rt of the number of light rays passing through the portion R2 to the number of light rays passing through the portion R1. As illustrated in FIG. 19, the ratio Rt is markedly elevated at an angle φ of the circumferential surface 138 equal to or larger than 150°. That is, designing the circumferential surface 138 to form an angle φ of 150° or larger can increase the number of light rays (light intensity) transmitted beyond the recess 130. The circumferential surface 138 thus preferably forms an angle φ of 150° or larger.

The following describes the liquid crystal display device 500. As illustrated in FIG. 1, the liquid crystal display device 500 includes the above-described backlight unit 200, the liquid crystal display panel 300, and the imaging unit 400. The following description focuses on the liquid crystal display panel 300 and the imaging unit 400.

The liquid crystal display panel 300 of the liquid crystal display device 500 is mounted on the projection 182 of the upper chassis 180 of the backlight unit 200. A typical example of the liquid crystal display panel 300 is a well-known transmissive liquid crystal display panel of an in-plane switching (IPS) mode. The liquid crystal display panel 300 is actively driven by a matrix of thin film transistors (TFTs). The liquid crystal display panel 300 modulates light from the backlight unit 200 and displays screen elements (characters, images, and other information). The liquid crystal display panel 300 includes the display region 302 and the frame region 304. The display region 302 includes pixels arranged in a matrix and can display screen elements. The display region 302 corresponds to the area 128a of the second main surface 128 of the light guide plate 120. The frame region 304 includes components, such as wires and drive circuits.

The imaging unit 400 of the liquid crystal display device 500 captures an image of a subject through the liquid crystal display panel 300. The imaging unit 400 includes the lens segment 410 and the body segment 420. The lens segment 410 extends through the through hole 174 of the lower chassis 170 and the through hole 152 of the reflective sheet 150, such that the end 412 of the lens segment 410 is located within the recess 130 of the light guide plate 120.

The lens segment 410 accommodates a lens system for forming an image of the subject at an image sensor, such as charge coupled device (CCD) image sensor. The body segment 420 is disposed on the rear side (-Z side) of the lower chassis 170. The body segment 420 accommodates components, such as the image sensor and circuit boards.

As above, in the backlight unit 200, in a cross-sectional view of the recess 130 of the light guide plate 120 in a plane perpendicular to the second main surface 128, the recess 130 has a circumferential surface 138 continuous to and obtusely inclined from a bottom surface 136 of the recess 130. This increases the luminance Lu in the portion SR of the light guide plate 120, leading to a more uniform luminance distribution in the light guide plate 120. The emission of highly uniform light from the backlight unit 200 can ensure excellent luminance uniformity of the liquid crystal display device 500.

### Embodiment 2

In Embodiment 1, the first main surface 126 of the light guide plate 120 is flat. The light guide plate 120 may have a protrusion 140 on the first main surface 126.

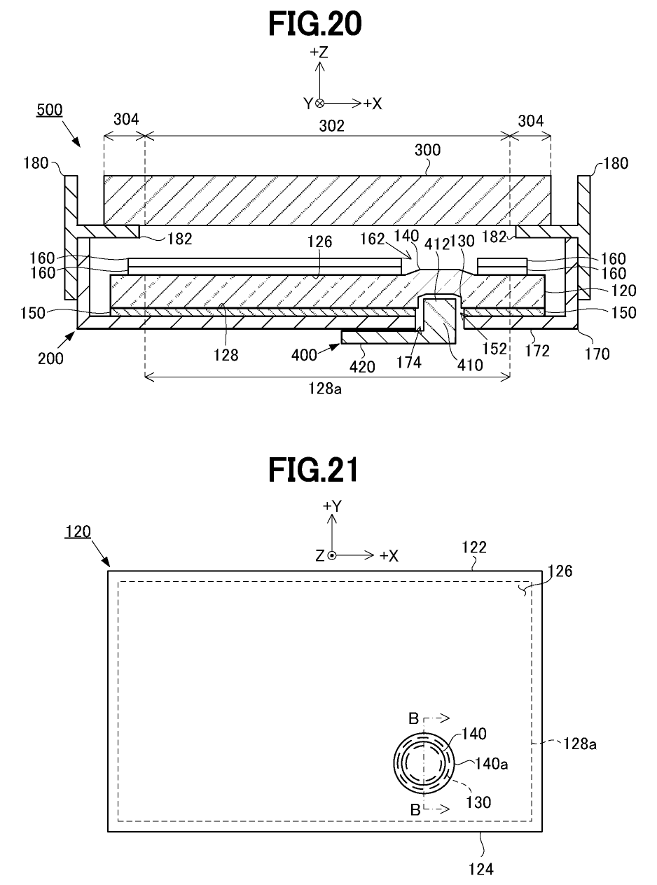

As illustrated in FIG. 20, the liquid crystal display device 500 in the embodiment includes the backlight unit 200, the liquid crystal display panel 300, and the imaging unit 400, similarly to the liquid crystal display device 500 in Embodiment 1. The backlight unit 200 in the embodiment includes the light sources 110, the light guide plate 120, the reflective sheet 150, the optical sheets 160, the lower chassis 170, and the upper chassis 180, similarly to the backlight unit 200 in Embodiment 1. The backlight unit 200 and the liquid crystal display device 500 in the embodiment have the same configurations as those in Embodiment 1, except for the light guide plate 120 and the optical sheets 160. The description focuses on the structure of the light guide plate 120 and the optical sheets 160 of the embodiment.

As illustrated in FIG. 20, the light guide plate 120 in the embodiment has a protrusion 140 on the first main surface 126. The light guide plate 120 in the embodiment has the same configuration as the light guide plate 120 in Embodiment 1, except for the protrusion 140. The protrusion 140 of the light guide plate 120 in the embodiment is described below.

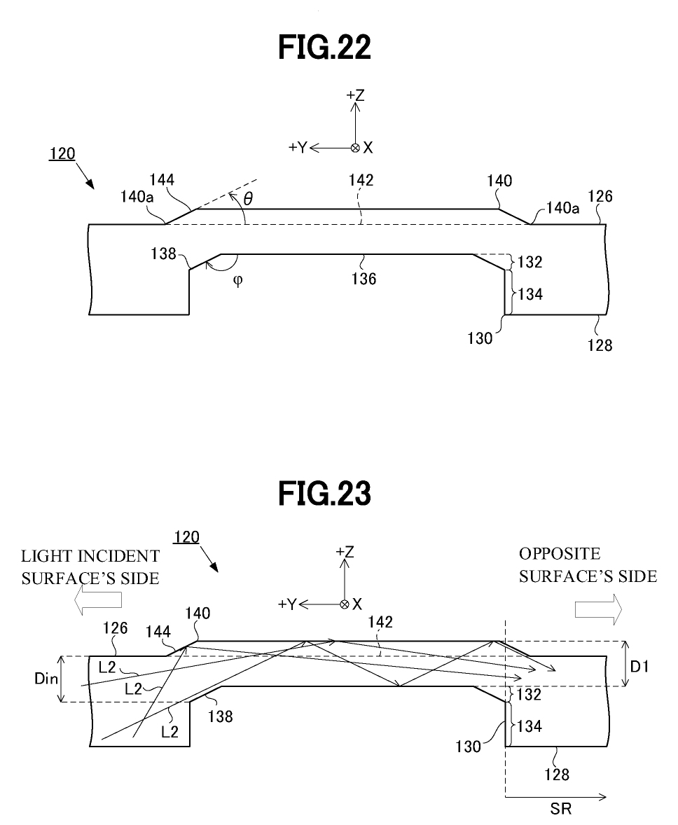

As illustrated in FIG. 21, the protrusion 140 has an outer circumference 140a that surrounds the recess 130 in plan view of the light guide plate 120 in the embodiment. The protrusion 140 has a truncated-cone shape. As illustrated in FIG. 22, the protrusion 140 has a trapezoidal cross section when viewed in a plane perpendicular to the first main surface 126, and the protrusion 140 has a circumferential surface 144 inclined at an acute angle from a bottom surface 142 of the protrusion 140 (inclination θ).

In the embodiment, the light guide plate 120 in this embodiment has a larger thickness D1 of the portion above the recess 130, due to the outer circumference 140a of the protrusion 140 surrounding the recess 130 in plan view. As illustrated in FIG. 23, this larger thickness D1 of the portion of the light guide plate 120 above the recess 130 enhances the intensity of the light transmitted beyond the recess 130 to the opposite portion SR of the light guide plate 120 as viewed from the light incident surface 122, among light L2 propagating within the light guide plate 120 from the side adjacent to the light incident surface 122 to the side adjacent to the opposite surface 124. The light L2 is also reflected by the circumferential surface 144 of the protrusion 140 and thus guided to the portion SR. These functions can further enhance the intensity of the light transmitted to the portion SR of the light guide plate 120, and thus increase the luminance Lu in the portion SR of the light guide plate 120, leading to a more uniform luminance distribution in the light guide plate 120 (light exit surface 126).

As illustrated in FIG. 20, the optical sheets 160 in the embodiment have through holes 162 designed in accordance with the protrusion 140. The other features of the optical sheets 160 in the embodiment are identical to those of the optical sheets 160 in Embodiment 1.

The following describes specific effects of the embodiment, on the basis of ray-trace simulations. In the simulation in the embodiment, the light sources 110 and the light guide plate 120 have the same configurations as those in the simulation in Embodiment 1, except for the dimension of the recess 130 and the protrusion 140. The description first focuses on the dimension of the recess 130 and the configuration of the protrusion 140 simulated in the embodiment.

As in Embodiment 1, the recess 130 has a rim segment 134 (-Z-side segment of the recess 130) that defines a circular-column depression, and the bottom segment 132 (+Z-side segment of the recess 130) that defines a mortar-like (truncated-cone) depression. The recess 130 has a central axis C1 positioned 90 mm in the -Y direction from the light incident surface 122 and 130 mm in the +X direction from the left side surface.

The light guide plate 120 has a thickness D2 of 3 mm, as in Embodiment 1. The portion of the light guide plate 120 above the recess 130 has a thickness D1 of 1.5 mm.

As illustrated in FIG. 24, the recess 130 has a depth DP1 of 2.0 mm in the embodiment. The bottom segment 132 of the recess 130 has a depth DP2 of 0.5 mm, and the rim segment 134 has a depth DP3 of 1.5 mm.

The recess 130 has a diameter DA1 of 18 mm, as in Embodiment 1. The circumferential surface 138 of the recess 130 is continuous to and forms an angle φ of 170° from the bottom surface 136 of the recess 130, as in Embodiment 1. The recess 130 in this simulation is provided with a light absorber therein.

The truncated-cone protrusion 140 has a central axis C2 that coincides with the central axis C1 of the recess 130. The bottom surface 142 of the protrusion 140 has a diameter DA2 of 21 mm. The protrusion 140 has a height H1 of 0.5 mm, and the circumferential surface 144 of the protrusion 140 has an inclination angle θ of 10°. The circumferential surface 144 of the protrusion 140 is parallel to the circumferential surface 138 of the recess 130 having an inclination angle φ of 170°.

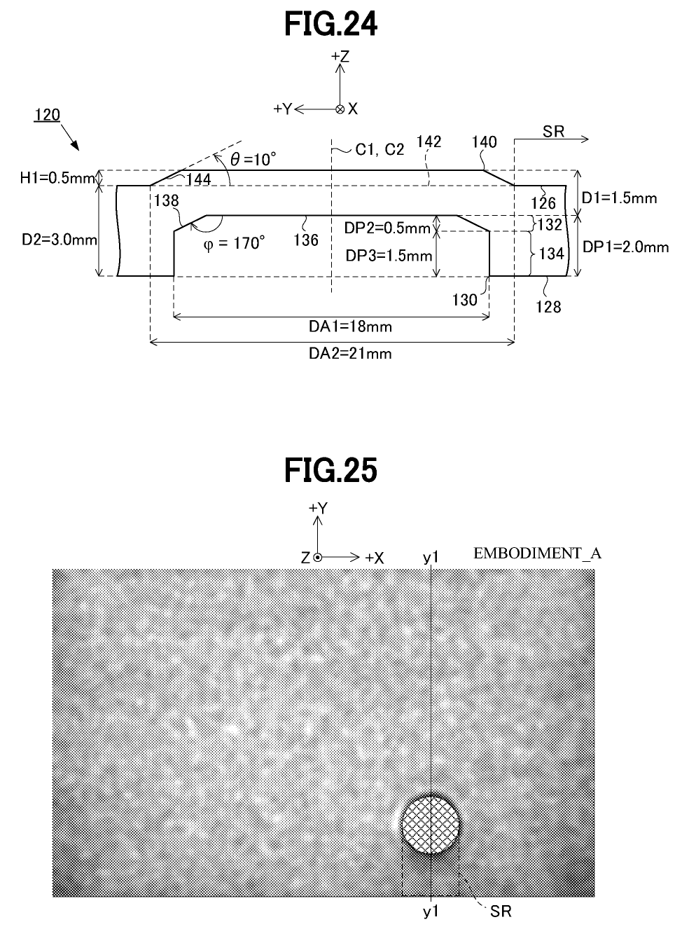

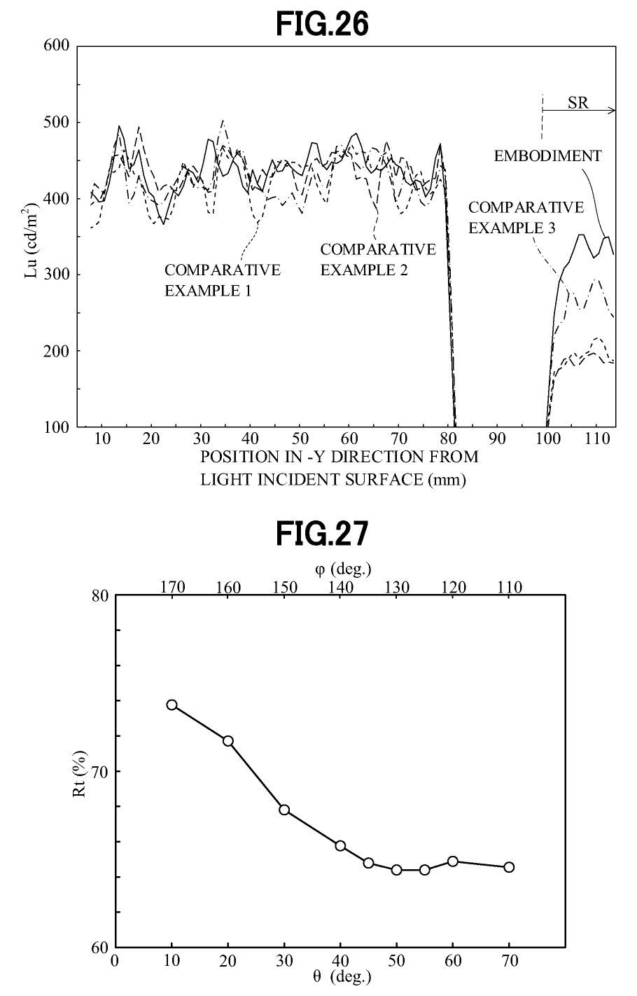

For the above-described light guide plate 120 in the embodiment, the luminance distribution on the light exit surface 126 (first main surface 126) was simulated. FIG. 25 illustrates luminance distributions of the light guide plate 120 in the embodiment. FIG. 26 illustrates a luminance distribution along the straight line (line y1-y1 in FIGS. 13 to 15 and 25) extending from the +Y side adjacent to the light incident surface 122 to the -Y side adjacent to the opposite surface 124 in parallel to the Y axis through the center of the recess 130, 842, or 862 or the through hole 822, in plan view of each of the light exit surfaces 126 in the embodiment and Comparative Examples 1 to 3 described in Embodiment 1.

As illustrated in FIGS. 25 and 26, the luminance Lu in the portion SR of the light guide plate 120 in the embodiment is higher than the luminance Lu in the portion SR of any of the light guide plates 820, 840, and 860 in Comparative Examples 1 to 3. The light guide plate 120 in the embodiment exhibits a more uniform luminance distribution than the light guide plates 820, 840, and 860 in Comparative Examples 1 to 3.

Then, the relationship between the angle φ of the circumferential surface 138 of the recess 130 or the angle θ of the circumferential surface 144 of the protrusion 140 in the light guide plate 120, and the ratio of light rays transmitted beyond the recess 130 was simulated. Specifically, a simulation was conducted, similarly to the simulation in Embodiment 1, to examine the relationship between the angle φ or the angle θ, and a ratio Rt of the number of light rays passing through the portion R2 of the light guide plate 120 immediately after the protrusion 140 to the number of light rays passing through the portion R1 of the light guide plate 120 immediately before the protrusion 140, as viewed from the light incident surface 122 (side surface 122). The circumferential surface 138 of the recess 130 is defined to be parallel to the circumferential surface 144 of the protrusion 140. The light guide plate 120 in this simulation has the same configuration as the light guide plate 120 in the above-described simulation, except for the values of the angle φ of the circumferential surface 138 and the angle θ of the circumferential surface 144.

FIG. 27 illustrates the relationship between the angle θ of the circumferential surface 144 or the angle φ of the circumferential surface 138, and the ratio Rt of the number of light rays passing through the portion R2 to the number of light rays passing through the portion R1. As illustrated in FIG. 27, the ratio Rt is markedly elevated at an angle θ of the circumferential surface 144 equal to or smaller than 40° or an angle φ of the circumferential surface 138 equal to or larger than 140°. The circumferential surface 144 thus preferably forms an angle θ of 40° or smaller, or the circumferential surface 138 preferably forms an angle φ of the 140° or larger, in the case where the circumferential surface 144 is parallel to the circumferential surface 138.

As above, in the backlight unit 200 according to the embodiment, in a cross-sectional view of the recess 130 of the light guide plate 120 in a plane perpendicular to the second main surface 128, the circumferential surface 138 of the recess 130 continuous to the bottom surface 136 of the recess 130 is obtusely inclined from the bottom surface 136. This structure can increase the luminance Lu in the portion SR of the light guide plate 120, and achieve a more uniform luminance distribution in the light guide plate 120, similarly to the backlight unit 200 in Embodiment 1. In the backlight unit 200 according to the embodiment, the outer circumference 140a of the protrusion 140 of the light guide plate 120 surrounds the recess 130 of the light guide plate 120 in plan view, and the protrusion 140 has a trapezoidal shape in cross-sectional view. This structure can further increase the luminance Lu in the portion SR of the light guide plate 120, and achieve a still more uniform luminance distribution on the light exit surface 126. The emission of highly uniform light from the backlight unit 200 can ensure excellent luminance uniformity of the liquid crystal display device 500.

### Embodiment 3

In Embodiment 2, the outer circumference 140a of the protrusion 140 of the light guide plate 120 surrounds the recess 130 of the light guide plate 120. That is, the diameter DA2 of the bottom surface 142 of the protrusion 140 is larger than the diameter DA1 of the recess 130 (DA2 > DA1). The diameter DA2 is preferably larger than the diameter DA1.

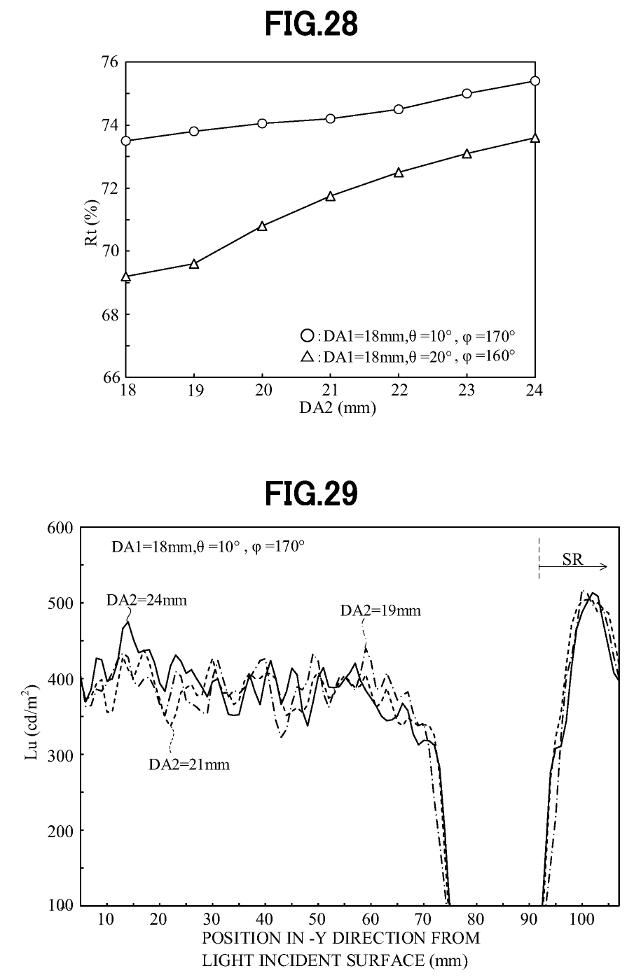

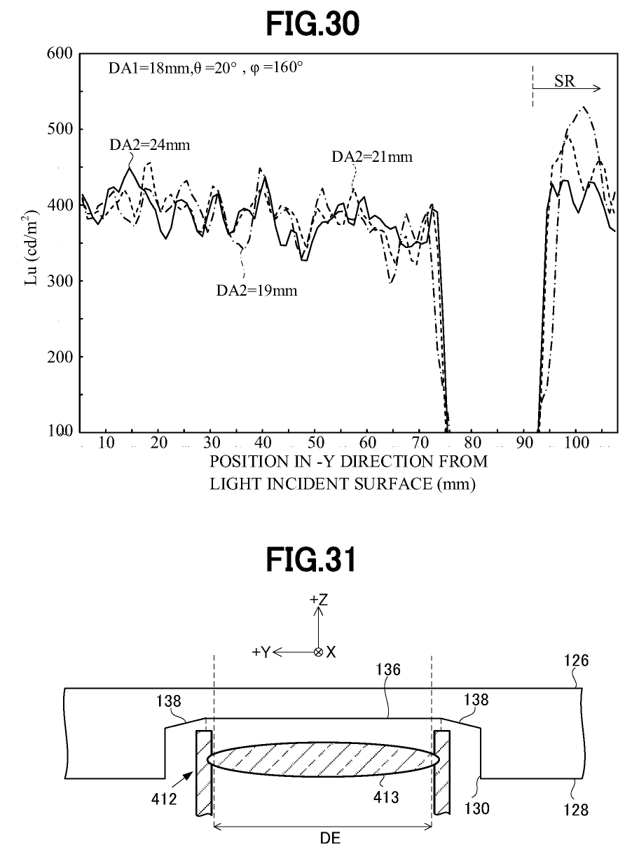

FIG. 28 illustrates the relationship between the diameter DA2 of the bottom surface 142 of the protrusion 140 and the ratio Rt of the number of light rays passing through the portion R2 of the light guide plate 120 immediately after the protrusion 140 to the number of light rays passing through the portion R1 of the light guide plate 120 immediately before the protrusion 140, as viewed from the light incident surface 122 (side surface 122) of the light guide plate 120 in Embodiment 2. FIGS. 29 and 30 each illustrate luminance distributions along a straight line on the light exit surface 126 of the light guide plate 120 in Embodiment 2. The straight line extends from the +Y side adjacent to the light incident surface 122 to the -Y side adjacent to the opposite surface 124 in parallel to the Y axis through the center of the recess 130, in plan view of the light exit surface 126.

FIGS. 28 to 30 are resulted from the simulations of different diameters DA2 of the bottom surface 142 of the protrusion 140, using the pattern B of diffusion layer, and defining the inclination angle θ of the circumferential surface 144 of the protrusion 140 to be 10°and the angle φ of the circumferential surface 138 of the recess 130 to be 170°, or defining the inclination angle θ of the circumferential surface 144 of the protrusion 140 to be 20° and the angle φ of the circumferential surface 138 of the recess 130 to be 160°. The other simulation conditions are identical to those in Embodiment 2. The recess 130 has a diameter DA1 of 18 mm (DA1 = 18 mm).

As illustrated in FIG. 28, the greater the diameter DA2 of the bottom surface 142 of the protrusion 140 compared to the diameter DA1 of the recess 130, the more light rays can be transmitted beyond the recess 130. The diameter DA2 is thus preferably larger than the diameter DA1.

As illustrated in FIGS. 29 and 30, such an extended diameter DA2 can also increase the luminance Lu in the portion SR and uniformize the luminance distribution in the light guide plate 120. An excessively large diameter DA2 may lower the luminance Lu around the recess 130 in the case where the optical sheets 160 have through holes 162 corresponding to the protrusion 140 as in the backlight unit 200 in Embodiment 2, because the through holes 162 expand in accordance with extension of the diameter DA2. The diameter DA2 is therefore appropriately determined depending on the use and required specifications, for example.

### Modifications

The above-described embodiments can be modified in various manners within the gist of the present disclosure.

For example, the light guide plate 120 in the above-described embodiments have a rectangular shape in plan view. The light guide plate 120 may have a shape other than the rectangular shape in plan view.

The rim segment 134 of the recess 130 may define a depression other than the circular-column depression. For example, the rim segment 134 of the recess 130 may define a prismatic-column depression. In the bottom segment 132 of the recess 130, the circumferential surface 138 of the recess 130 continuous to the bottom surface 136 of the recess 130 is only required to be obtusely inclined from the bottom surface 136. For example, the bottom segment 132 may define a truncated-pyramid depression designed in accordance with the shape of the rim segment 134.

The light guide plate 120 in the above-described embodiments is provided with the diffusion layer for outputting the light emitted from the light sources 110, on the second main surface 128 except for the recess 130. The light guide plate 120 is only required to include any mechanism for outputting the light emitted from the light sources 110. For example, the light guide plate 120 may be provided with a fine prism structure on the second main surface 128 except for the recess 130.

The end 412 of the lens segment 410 of the imaging unit 400 is located within the recess 130 of the light guide plate 120 in the above-described embodiments. As illustrated in FIG. 31, the circumferential surface 138 of the recess 130 preferably has no overlap with the effective aperture DE of a lens 413 located closest to the subject in the lens segment 410. This structure enables the imaging unit 400 to capture an image of the subject while reducing the effects of light refraction or reflection at the circumferential surface 138 inclined from the second main surface 128. In Embodiment 2, at least one of the circumferential surface 138 of the recess 130 and the circumferential surface 144 of the protrusion 140 preferably has no overlap with the effective aperture DE of the lens 413 located closest to the subject in the lens segment 410.

The recess 130 of the light guide plate 120 houses at least part of the imaging unit 400. For example, the recess 130 may house the entire imaging unit 400.

The recess 130 of the light guide plate 120 may house a component other than the imaging unit 400. For example, the recess 130 may house any of various sensors.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A backlight unit, comprising:
a light source; and
a light guide plate including
a side surface facing the light source,
a first main surface through which light from the light source is output, and
a second main surface opposite to the first main surface, wherein
the light guide plate includes a recess disposed on the second main surface,
the recess includes a bottom surface and a circumferential surface continuous to the bottom surface, and
the circumferential surface is obtusely inclined from the bottom surface when the recess is viewed in a plane perpendicular to the second main surface.

2. The backlight unit according to claim 1, wherein
the light guide plate includes a protrusion disposed on the first main surface,
when the protrusion is viewed in plan, an outer circumference of the protrusion surrounds the recess, and
the protrusion has a trapezoidal cross section when viewed in a plane perpendicular to the first main surface.

3. The backlight unit according to claim 2, further comprising:
at least one optical sheet stacked on the first main surface of the light guide plate, wherein
the at least one optical sheet has a through hole designed in accordance with the protrusion of the light guide plate.

4. The backlight unit according to claim 1, wherein
the circumferential surface of the recess has an inclination angle of 150° or larger from the bottom surface of the recess.

5. A liquid crystal display device, comprising:
the backlight unit according to claim 1; and
a liquid crystal display panel disposed on the first main surface of the light guide plate and including a display region to display screen elements, wherein
the recess of the light guide plate overlaps with the display region of the liquid crystal display panel in plan view.

6. The liquid crystal display device according to claim 5, wherein
the recess of the light guide plate houses at least part of an imaging unit.
